(19) United States
(12) Patent Application Publication
(10) Pub. No.: US 2020/0356971 A1
(43) Pub. Date: Nov. 12, 2020

(54) INFORMATION MANAGEMENT APPARATUS, INFORMATION PROVIDING SYSTEM, AND INFORMATION PROCESSING METHOD

(71) Applicant: TOSHIBA TEC KABUSHIKI KAISHA, Tokyo (JP)

(72) Inventor: Toshihide MURATA, Izunokuni Shizuoka (JP)

(21) Appl. No.: 16/721,415

(22) Filed: Dec. 19, 2019

(30) Foreign Application Priority Data
May 8, 2019 (JP) 2019-088455

(51) Int. Cl. G06Q 20/20; G06Q 20/38; G06Q 30/02

(52) U.S. Cl. CPC G06Q 20/202; G06Q 30/0238; G06Q 20/209; G06Q 20/387

(57) ABSTRACT

According to an embodiment, an information management apparatus, which is connected to a providing apparatus that provides information to a customer, includes a storage device and a processor. The processor selects, from a plurality of pieces of to-be-provided information stored in the storage device, to-be-provided information with which incentive data that matches an incentive condition preset for the providing apparatus is associated.

### CROSS-REFERENCE TO RELATED APPLICATIONS

This application is based upon and claims the benefit of priority from the prior Japanese Patent Application No. 2019-088455, filed on May 8, 2019, the entire contents of which are incorporated herein by reference.

### FIELD

An embodiment to be described here generally relates to an information management apparatus, an information providing system, and an information processing method.

### BACKGROUND

In an apparatus such as a (point-of-sale) POS terminal operated by a retailer, issuing a coupon in response to a request from a manufacturer of a product and giving the coupon to a customer has been already performed. This is realized by, for example, issuing a coupon at the POS terminal in response to an instruction from a coupon distribution server. The coupon distribution server instructs the POS terminal to issue a coupon that the manufacturer or the like desires to distribute. Note that selecting a coupon to be issued in consideration of attributes such as age and sex of the customer, or transaction details associated with the product being purchased by the customer this time or in the past, or the like has also been performed. That is, actually, the coupon to be issued is determined by the various circumstances of the manufacturer and the customer.

Incidentally, issuing and permitting use of a coupon can be expensive for a retailer. Though, the retailer can also receive various benefits such as the effect of attracting customers by the coupon. However, the use rate for the amount of issued coupons, the ratio of the use amount for each type of coupons, or the like differs depending on the absolute number of customers, the customer structure, and the like. For this reason, the cost and benefit relating to coupon issuance differ for each retailer. For this reason, the issue of the coupon determined on the basis of the circumstances of the manufacturer and the customer is not an appropriate coupon issue for the retailer in some cases.

Note that in the POS terminal or the like, inserting an advertising image in a receipt, or printing an advertisement on a receipt paper separately from a receipt and outputting it has also been performed. However, the same as in the case of the above-mentioned coupon applies also to these cases. Specifically, the above-mentioned problem occurs in common in the case where some information provided by a provider such as a manufacturer is given to a recipient such as a customer using an apparatus operated by an intermediary such as a retailer. In view of such circumstances, it has been desired for the intermediary to be capable of appropriately and efficiently providing information.

### BRIEF DESCRIPTION OF THE DRAWINGS

FIG. 1 is a block diagram showing a schematic configuration of a coupon distribution system according to an embodiment.

FIG. 2 is a block diagram showing a circuit configuration of main parts of a coupon server and a POS terminal according to an embodiment.

FIG. 3 is a diagram showing an example of a structure of record data included in a management database according to the embodiment.

FIG. 4 is a flowchart showing information processing by a processor of the POS terminal according to the embodiment.

FIG. 5 is a flowchart showing information processing by a processor of the coupon server according to the embodiment.

### DETAILED DESCRIPTION

According to an embodiment, an information management apparatus is communicably connected to a providing apparatus that can be operated by an intermediary, the intermediary provides, to a customer, to-be-provided information from an information provider. Further, the information management apparatus manages a plurality of pieces of to-be-provided information, the plurality of pieces of to-be-provided information being output by the providing apparatus. The information management apparatus includes a communication interface, a storage device, and a processor. The communication interface communicates with the providing apparatus. The storage device stores incentive data in association with the to-be-provided information. The incentive data indicates an incentive to be given from the information provider to the intermediary. The processor acquires, as the incentive, an incentive condition preset for the providing apparatus. The processor selects, from the plurality of pieces of to-be-provided information stored in the storage device, to-be-provided information with which the incentive data that matches the acquired incentive condition is associated. Further, the processor outputs the selected to-be-provided information to the providing apparatus via the communication interface.

Hereinafter, an example of the embodiment will be described with reference to the drawings. Note that in this embodiment, a coupon server having a function as an information management apparatus will be described as an example. Further, in this embodiment, a coupon distribution system as an information providing system, which includes the coupon server and a POS terminal having a function as an information providing apparatus, will be described as an example. In the figures, the same reference symbols indicate the same or similar components.

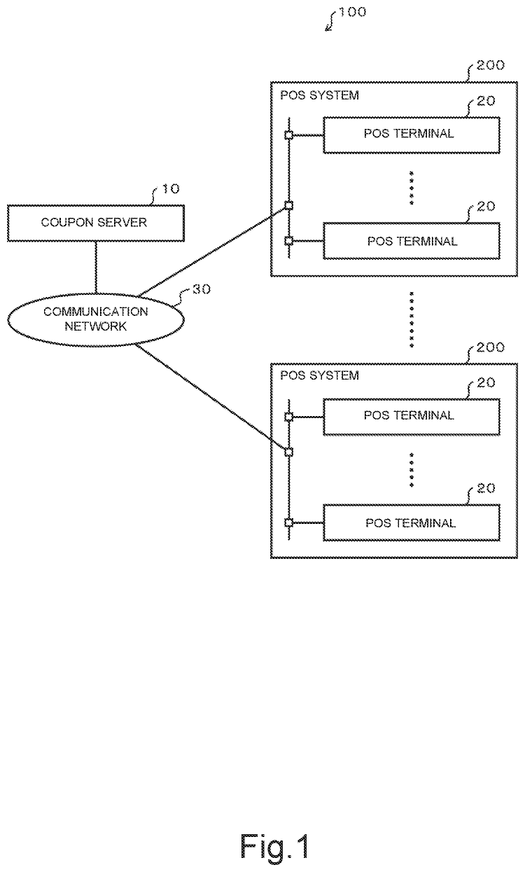

FIG. 1 is a block diagram showing a schematic configuration of a coupon distribution system 100 according to this embodiment. In this coupon distribution system 100, a coupon server 10 and a plurality of POS terminals 20 can communicate with each other via a communication network 30.

The coupon server 10 manages, for example, coupons provided by a provider such as a manufacturer and a former seller of a product. The coupon server 10 may be operated by the above-mentioned provider or may be operated by another management agent. The coupon server 10 selects, in response to an inquiry from the POS terminal 20, a coupon to be issued from the coupons that the coupon server 10 manages. The coupon server 10 instructs the POS terminal 20 that is the source of the inquiry to issue the selected coupon.

Each of the POS terminals 20 belongs to any of a plurality of POS systems 200. The plurality of POS systems 200 are typically provided in different stores. However, the plurality of POS systems 200 may be provided in one store, or one POS system 200 may be provided across a plurality of stores.

In this way, each of the POS terminals 20 is operated by a retailer that operates the store in which the POS system 200 to which the corresponding POS terminal 20 belongs is provided. The POS terminal 20 registers content of an arbitrary commercial transaction, such as sale of products, provision of food and drinks, and provision of services, and performs information processing for accounting the commercial transaction. Then, the POS terminal 20 issues, in response to an instruction from the coupon server 10, a coupon to be given to a shopper along with such a commercial transaction. In this way, the above-mentioned retailer is an intermediary for giving a coupon. Note that the plurality of stores in which the plurality of POS systems 200 is provided may be operated by a single retailer or a plurality of different retailers.

As the communication network 30, the Internet, a virtual private network (VPN), a local area network (LAN), a public communication network, a mobile communication network, and the like can be used alone or in combination as appropriate. As the communication network 30, the Internet and the VPN are used in combination as an example.

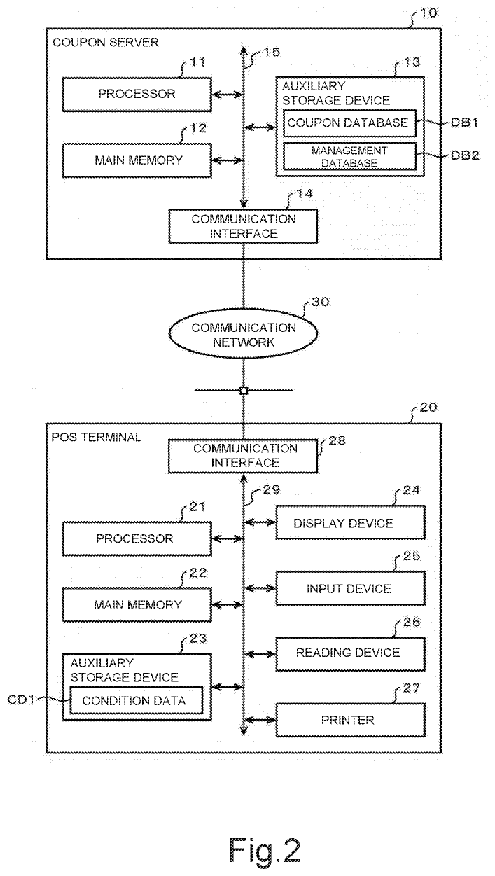

FIG. 2 is a block diagram showing a circuit configuration of main parts of the coupon server 10 and the POS terminal 20. The coupon server 10 includes a processor 11, a main memory 12, an auxiliary storage device 13, a communication interface 14, and a transmission path 15. The processor 11, the main memory 12, the auxiliary storage device 13, and the communication interface 14 are connected to each other via the transmission path 15. The processor 11, the main memory 12, and the auxiliary storage device 13 are connected to each other via the transmission path 15, thereby configuring a computer that performs information processing for controlling the coupon server 10.

The processor 11 corresponds to the brain of the above-mentioned computer. The processor 11 executes information processing for realizing various functions as the coupon server 10 in accordance with an information processing program such as an operating system, middleware, and an application program.

The main memory 12 corresponds to the main memory part of the above-mentioned computer. The main memory 12 includes a non-volatile memory area and a volatile memory area. The main memory 12 stores the above-mentioned information processing program in the non-volatile memory area. Further, the main memory 12 stores, in the non-volatile memory area or volatile memory area, data necessary for the processor 11 to execute processing for controlling the respective units in some cases. The main memory 12 is used as a work area in which the processor 11 appropriately rewrites data in the volatile memory area.

The auxiliary storage device 13 corresponds to an auxiliary storage part of the above-mentioned computer. As the auxiliary storage device 13 is, for example, an electric erasable programmable read-only memory (EEPROM), a hard disc drive (HDD), a solid state drive (SSD), or various other known storage devices can be used. The auxiliary storage device 13 stores data to be used by the processor 11 for executing various types of processing, and data generated by the processing executed by the processor 11. The auxiliary storage device 13 stores the above-mentioned information processing program in some cases.

The communication interface 14 executes data communication via the communication network 30. As the communication interface 14, for example, a known device that executes known processing for data communication via the Internet can be used. The transmission path 15 includes an address bus, a data bus, a control signal line, and the like, and transmits data and control signals to be exchanged between the respective units connected to the transmission path 15.

The coupon server 10 can be realized by, for example, using a general-purpose computer apparatus for a server as hardware and storing an information processing program describing information processing described below in the main memory 12 or the auxiliary storage device 13. Note that the information processing program may be stored in the main memory 12 or the auxiliary storage device 13 when the coupon server 10 is transferred, or may be transferred separately from the above-mentioned general-purpose computer apparatus. In the latter case, the information processing program is transferred by being recorded in a removable recording medium such as a magnetic disc, a magneto-optical disc, an optical disc, and a semiconductor memory or via a network.

The POS terminal 20 includes a processor 21, a main memory 22, an auxiliary storage device 23, a display device 24, an input device 25, a reading device 26, a printer 27, a communication interface 28, and a transmission path 29. The processor 21, the main memory 22, the auxiliary storage device 23, the display device 24, the input device 25, the reading device 26, the printer 27, and the communication interface 28 are connected to each other via the transmission path 29. The processor 21, the main memory 22, and the auxiliary storage device 23 are connected to each other via the transmission path 29, thereby configuring a computer that performs information processing for controlling the POS terminal 20.

The processor 21 corresponds to the brain of the above-mentioned computer. The processor 21 executes information processing for realizing various functions as the POS terminal 20 in accordance with an information processing program such as an operating system, middleware, and an application program.

The main memory 22 corresponds to the main memory part of the above-mentioned computer. The main memory 22 includes a non-volatile memory area and a volatile memory area. The main memory 22 stores the above-mentioned information processing program in the non-volatile memory area. Further, the main memory 22 stores, in the non-volatile memory area or volatile memory area, data necessary for the processor 21 to execute processing for controlling the respective units in some cases. The main memory 22 is used as a work area in which the processor 21 appropriately rewrites data in the volatile memory area.

The auxiliary storage device 23 corresponds to an auxiliary storage part of the above-mentioned computer. As the auxiliary storage device 23, for example, an EEPROM, an HDD, a SSD, or various other known storage devices can be used. The auxiliary storage device 23 stores data to be used by the processor 21 for executing various types of processing, and data generated by the processing executed by the processor 21. The auxiliary storage device 23 stores an information processing program in some cases. One of pieces of data to be stored in the auxiliary storage device 23 is condition data CD1. The condition data CD1 indicates a condition (hereinafter, referred to as the incentive condition) relating to an incentive necessary for issuing a coupon. The incentive condition is typically set to “oo yen or more”, for example. However, the incentive condition may be arbitrarily set by an administer of the POS terminal 20, or the like, and may be set to “oo yen or less”, “oo yen or more and oo yen or less”, or the like. Note that it does not necessarily need to set the incentive condition. In this case, the condition data CD1 is not stored in the auxiliary storage device 23. The condition data CD1 is updated by the processor 21 in accordance with an instruction or the like by the administrator or the like using the input device 25.

The display device 24 displays various screens for notifying an operator of various types of information. As the display device 24, for example, a known device such as a liquid crystal display device can be used. The input device 25 inputs various instructions by the operator. As the input device 25, known devices such as a touch sensor and a keyboard can be used alone or in combination.

The reading device 26 reads data stored in a storage medium. As the reading device 26, a known device such as a barcode scanner and a card reader can be used alone or in combination. The printer 27 prints various images on a receipt paper.

The communication interface 28 performs data communication via the communication network 30. As the communication interface 28, for example, a known device that performs known processing for data communication via the Internet can be used. The transmission path 29 includes an address bus, a data bus, a control signal line, and the like, and transmits data and control signals to be exchanged between the respective units connected to the transmission path 29.

The POS terminals 20 stores, in the main memory 22 or the auxiliary storage device 23, an information processing program describing information processing described below. Note that the information processing program may be stored in the main memory 22 or the auxiliary storage device 23 when hardware of the POS terminals 20 is transferred or may be transferred separately from the above-mentioned hardware. In the latter case, the information processing program is transferred by being recorded in a removable recording medium such as a magnetic disc, a magneto-optical disc, an optical disc, and a semiconductor memory or via a network. In the latter case, assumption is made that the information processing program is provided as a version upgrade program and used by being replaced with another information processing program of the same type that has been stored in the main memory 22 or the auxiliary storage device 23.

Incidentally, the data to be stored in the auxiliary storage device 13 includes a coupon database DB1 and a management database DB2. The coupon database DB1 is a set of record data associated with each of a large number of coupons. The record data of the coupon database DB1 indicates what kind of coupon each of the large number of coupons is. The record data includes a coupon code for identifying each of the large number of coupons. The record data includes image data that represents a surface of the coupon. The record data may include data that indicates content of a privilege, an application target of a privilege, an application condition of a privilege, or the like.

The management database DB2 is a set of a large number of pieces of record data associated with the coupons with which the pieces of record data included in the coupon database DB1 are associated. The record data of the management database DB2 is data for managing the coupon associated with the corresponding record data.

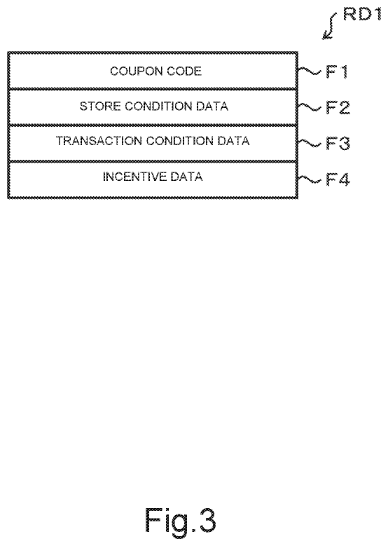

FIG. 3 is a diagram showing an example of a structure of record data RD1 included in the management database DB2. The record data RD1 includes fields F1, F2, F3, and F4. In the field F1, a coupon code of the coupon with which the record data RD1 is associated is set. In the field F2, store condition data that indicates a condition for narrowing down stores that issue the coupon with which the record data RD1 is associated is set. In the field F3, transaction condition data that indicates a condition for narrowing down in which transaction the coupon with which the record data RD1 is associated is issued is set. In the field F4, incentive data that indicates content of an incentive for the retailer issuing the coupon with which the record data RD1 is associated is set.

In this way, one of the pieces of record data of the coupon database DB1 and one piece of the record data RD1 of the management database DB2 make a pair. When a new coupon is added as a management target in the coupon server 10, the pair of pieces of record data is added to the coupon database DB1 and the management database DB2 by the processor 11 in response to an instruction from a provider of the coupon.

Next, an operation of the coupon distribution system 100 configured as described above will be described. Note that content of processing described below is an example. For example, the order of a part of processes can be changed, a part of processes can be omitted, or other process can be added as appropriate. In the case where the POS terminals 20 is in an operation state in which registration of transaction and accounting are to be performed, the processor 21 executes information processing described below in accordance with the information processing program stored in the main memory 22 or the auxiliary storage device 23.

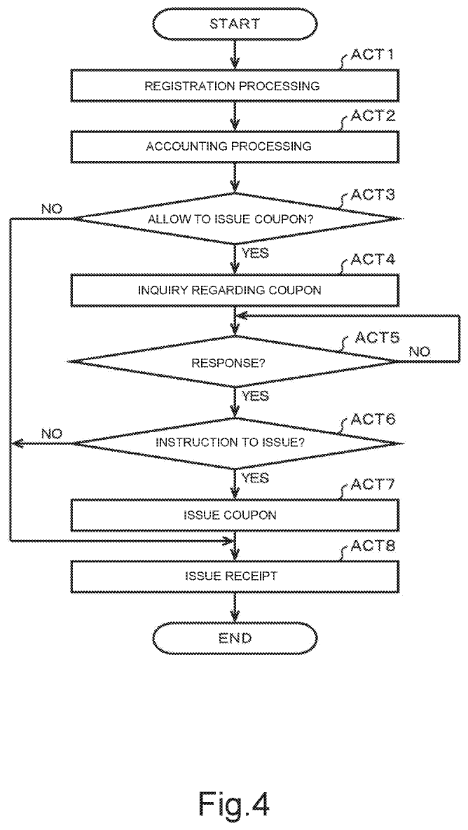

FIG. 4 is a flowchart showing information processing by the processor 21.

Note that with the start of the information processing shown in FIG. 4, the processor 21 performs, for example, preparatory processing such as initialization or deletion of data to be temporarily used, in information processing relating to one transaction, e.g., a product list table.

In ACT1 shown in FIG. 4, the processor 21 executes registration processing. The registration processing is processing for registering, as a transaction target, a product that a shopper intends to purchase. Specifically, the processor 21 stands by until a registration operation is performed. The registration operation is an operation performed by an operator for designating a product that he/she intends to purchase. Note that the operator may be any of a store clerk and a shopper. The operator performs the registration operation in the case of starting registration. The registration operation is performed as an operation for causing the reading device 26 to read the barcode corresponding to the product, an operation of the input device 25 predetermined for designating a product, or the like. In the case where the registration operation is performed in this way, the processor 21 acquires a product code identified on the basis of information acquired by the reading device 26 or a product code identified on the basis of the operation of the input device 25. The processor 21 updates the product list table in order to add the acquired product code as a product code relating to the product to be traded (hereinafter, referred to as the purchasing product). At this time, the processor 21 may constantly obtain the latest subtotal by adding the unit price of the purchasing product to be added this time to the subtotal.

Next, in ACT2, the processor 21 executes accounting processing. The accounting processing is processing for calculating a price for all the purchasing products and paying the price. The processor 21 basically calculates the sum of unit prices of all the purchasing products as the prices. However, the processor 21 performs a reduction or a discount on the unit price or the sum of the unit prices as necessary. Then, the processor 21 pays the calculated prices by using a payment medium such as cash, a credit card, a debit card, a prepaid card, electronic money, points, and a voucher.

In ACT3, the processor 21 checks whether or not the operation setting is setting that allows a coupon to be issued. Note that the operation setting is performed by, for example, the administrator of the POS terminal 20. The operation setting is stored in, for example, an auxiliary storage device of the POS terminal 20. Then, in the case where the processor 21 determines that the coupon has been allowed to be issued (YES in ACT3), the processing of the processor 21 proceeds to ACT4.

In ACT4, the processor 21 makes an inquiry to the coupon server 10 regarding a coupon to be issued. Specifically, the processor 21 generates inquiry data including the condition data CD1 and a command that allows the coupon server 10 to identify that it is an inquiry regarding a coupon. The inquiry data includes data regarding the store in which the POS terminal 20 is provided. Note that in the case where the condition data CD1 is not stored in the auxiliary storage device 23, the processor 21 does not cause the inquiry data to include the condition data CD1. In the case where attribute data regarding an attribute of a shopper can be acquired, the processor 21 may cause the inquiry data to include the attribute data. The attribute data of the shopper is data indicating a member code assigned to the shopper, age, sex, or the like, but is not limited thereto. Further, the processor 21 may cause the inquiry data to include the entire product list table or a part of product codes included in the product list table. Then, the processor 21 transmits the generated inquiry data, which is addressed to the coupon server 10, from the communication interface 28 to the communication network 30. The inquiry data transmitted by the communication network 30 to the coupon server 10 is taken into the coupon server 10 by the communication interface 14. The processor 21 executes the information processing based on the information processing program in this way, and thus, the computer that includes the processor 21 as the brain functions as a notification means.

In the coupon server 10, the processor 11 stands by until the POS terminal 20 makes an inquiry regarding a coupon. Then, in the case where inquiry data has been taken in by the communication interface 14 as described above, the processor executes information processing described below in accordance with the information processing program stored in the main memory 12 or the auxiliary storage device 13.

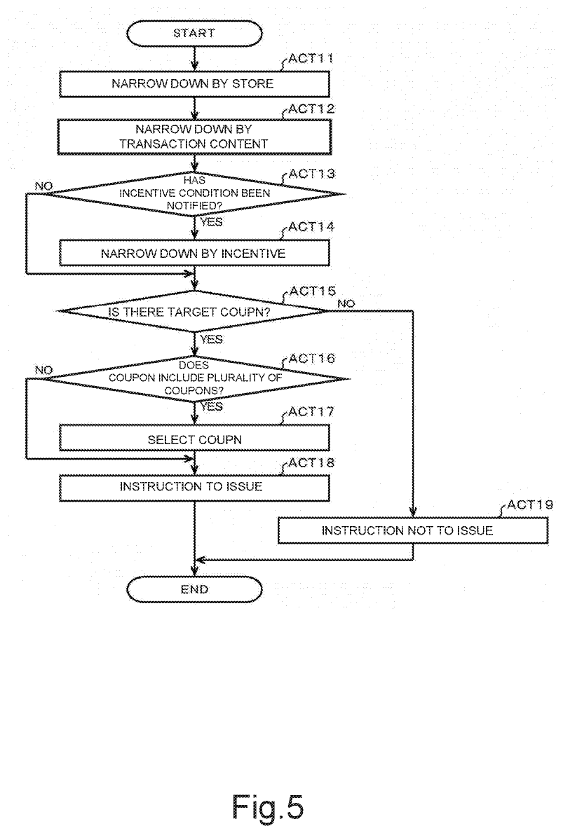

FIG. 5 is a flowchart of the information processing by the processor 11. In ACT11 shown in FIG. 5, the processor 11 narrows down, to coupons to be issued, a large number of coupons with which the pieces of record data included in the coupon database DB1 (see FIG. 2) are associated, in accordance with the store in which the POS terminal 20 that has transmitted the above-mentioned inquiry data is provided. For example, the processor 11 extracts, from the management database DB2, the record data RD1 (see FIG. 3) in which the store condition data that indicates the condition that the data of the store in which the POS terminal 20 is provided, which is the source of the inquiry, matches is set in the field F2. The coupons with which the pieces of record data RD1 thus extracted are associated are each a coupon after the narrowing down in ACT11.

Next, in ACT12, the processor 11 further narrows down, to coupons to be issued, the coupons narrowed down in ACT11, in accordance with the content of transaction. For example, the processor 11 extracts, from the pieces of record data RD1 extracted in ACT11, the record data RD1 in which the condition data that indicates the condition that the purchasing product identified by the product code included in the inquiry data or the attribute of the shopper indicated by the attribute data included in the inquiry data matches is set in the field F3. Note that the processor 11 may refer to the product that the shopper identified by the attribute of the shopper indicated by the attribute data included in the inquiry data has purchased in the past transaction to determine whether or not it matches the condition indicated by the condition data in the field F3. The coupons with which the pieces of record data RD1 thus extracted are associated are each a coupon after the narrowing down in ACT12.

In ACT13, the processor 11 checks whether or not the incentive condition has been notified. For example, the processor 11 checks whether or not the inquiry data includes the condition data CD1. Then, in the case where the processor 11 has checked that the inquiry data includes the condition data CD1 (incentive condition) (YES in ACT1), the processing of the processor 11 proceeds to ACT14.

In ACT14, the processor 11 narrows down, to coupons to be issued, the coupons narrowed down in ACT12, in accordance with the incentive. For example, the processor 11 extracts, from the pieces of record data RD1 extracted in ACT12, the record data RD1 in which the incentive data that indicates the incentive that the incentive condition indicated by the condition data CD1 included in the inquiry data matches is set in the field F4. The coupons with which the pieces of record data RD1 thus extracted are associated are each a coupon after the narrowing down in ACT14. The processor 11 executes the information processing based on the information processing program in this way, and thus, the computer including the processor 11 as the brain functions as a selection means. After that, the processing of the processor 11 proceeds to ACT15. Note that in the case where the processor 11 has checked that the inquiry data does not include the condition data CD1 (NO in ACT1), the processing of the processor 11 passes ACT14 and proceeds to ACT15.

In ACT15, the processor 11 checks whether or not there is a coupon to be issued. For example, the processor 11 checks whether or not even one piece of record data RD1 has been extracted by the narrowing down so far. Then, in the case where the processor 11 has checked that the record data RD1 has been extracted (YES in ACT15), the processing of the processor 11 proceeds to ACT16.

In ACT16, the processor 11 checks whether or not the coupon to be issued includes a plurality of coupons. For example, the processor 11 checks whether or not the record data RD1 that has been extracted by the narrowing down so far includes a plurality of pieces of record data RD1. Then, in the case where the processor 11 has checked that the plurality of pieces of record data RD1 has been extracted (YES in ACT16), the processing of the processor 11 proceeds to ACT17.

In ACT17, the processor 11 selects, from the coupons narrowed down so far, one coupon as a coupon to be issued. For example, the processor 11 selects a coupon in accordance with a predetermined rule. The rule may be arbitrarily set by, for example, the administrator of the coupon server 10. Further, the processor 11 may select a plurality of coupons as coupons to be issued. In the case where the narrowing down in ACT14 has been executed, the coupon thus selected is a coupon in which the incentive that matches the incentive condition is set. The processor 11 executes the information processing based on the information processing program in this way, and thus, the computer including the processor 11 as the brain functions as a selection means. After that, the processing of the processor 11 proceeds to ACT18. Note that in the case where the processor 11 has checked that the record data RD1 that has been extracted by the narrowing down so far includes only one piece of record data RD1 (NO in ACT16), the processing of the processor 11 passes ACT17 and proceeds to ACT18.

In ACT18, the processor 11 instructs the POS terminal 20 that is the source of the inquiry to issue a coupon. Specifically, the processor 11 generates response data that includes coupon data and a command that allows the POS terminal 20 to identify that it is a response to the inquiry. The coupon data includes image data that represents a surface of the coupon selected in ACT17 or coupon narrowed down to one in ACT11 to ACT14. The processor 11 reads the corresponding image data from the coupon database DB1 and causes the response data to include the read image data. Then, the processor 21 transmits the generated response data, which is addressed to the POS terminal 20 that is the source of the inquiry, from the communication interface 14 to the communication network 30. Then, the processor 11 finishes the processing shown in FIG. 5. The processor 11 executes the information processing based on the information processing program in this way, and thus, the computer including the processor 11 as the brain functions as an instruction means.

Meanwhile, in the case where the processor 11 has checked that the record data RD1 has not been extracted by the narrowing down in ACT11 to ACT14 (NO in ACT15), the processing of the processor 11 proceeds to ACT19.

In ACT19, the processor 11 instructs the POS terminal 20 that is the source of the inquiry not to issue a coupon. Specifically, the processor 11 generates response data that includes a command that allows the POS terminal 20 to identify that it is a response to the inquiry but does not include coupon data. Then, the processor 21 transmits the generated response data, which is addressed to the POS terminal 20 that is the source of the inquiry, from the communication interface 14 to the communication network 30. Then, the processor 11 finishes the processing shown in FIG. 5.

The response data transmitted to the POS terminal 20 that is the source of the inquiry by the communication network 30 is taken into the POS terminal 20 that is the source of the inquiry by the communication interface 28. Meanwhile, the processing of the processor 21 of the POS terminal 20 that is the source of the inquiry proceeds to ACT5 after the inquiry in ACT4 shown in FIG. 4. In ACT5, the processor 21 stands by until there is a response to the inquiry in ACT4. Then, in the case where the processor 21 has checked that the communication interface 28 has taken in the response data as described above (YES in ACT5), the processing the processor 21 proceeds to ACT6.

In ACT6, the processor 21 checks whether or not issue of a coupon is instructed. For example, the processor 21 checks whether or not the response data that has been taken in by the communication interface 28 as described above includes coupon data. In the case where the processor 21 has checked that the response data includes coupon data (YES in ACT6), the processing of the processor 21 proceeds to ACT7. In ACT7, the processor 21 issues a coupon. For example, the processor 21 provides the image data included in the coupon data to the printer 27 and instructs the printer 27 to print the image data. In response to this instruction, the printer 27 prints the coupon surface represented by the provided image data on a receipt paper. As a result, a coupon is issued. Such issuing of a coupon is an example of the output of information. The processor 21 executes the information processing based on the information processing program in this way, and thus, a function as an output means is realized by cooperation of the printer 27 and the computer that includes the processor 21 as the brain. The issued coupon is handed to a shopper by a store clerk or removed from the POS terminal 20 by a shopper. Then, after the printer 27 finishes printing the coupon, the processing of the processor 21 proceeds to ACT8. Note that in the case where the processor 21 has determined that the coupon has not been allowed to be issued (NO in ACT3), the processing of the processor 21 passes ACT4 to ACT7 and proceeds to ACT8. Further, in the case where an instruction not to issue a coupon has been made by the coupon server 10 and the processor 21 has checked that the response data that has been taken in by the communication interface 28 as described above does not include coupon data (NO in ACT6), the processing of the processor 21 passes ACT7 and proceeds to ACT8.

In ACT8, the processor 21 issues a receipt. For example, the processor 21 generates an image that represents the content of transaction, such as a list of purchasing products and the execution status of payment. Specifically, the processor 21 generates, on the basis of the result of the product list and payment processing, a transaction receipt image that represents a character string or the like representing the transaction content. The processor 21 causes the transaction receipt image to include, for example, a store code, date and time, a cash register number, a store clerk code, a store clerk name, a user code, a product code, a unit price, a subtotal amount, a tax amount, a total amount, a deposit amount, a change amount, the number of transaction, and a receipt number. Then, the processor 21 provides image data that represents the generated image to the printer 27 and instructs the printer 27 to print the image data. In response to this instruction, the printer 27 prints the image based on the provided image data on a receipt paper. As a result, a receipt is issued. The receipt issued in this way is handed to a shopper by a store clerk or removed from the POS terminal 20 by a shopper. Then, in the case where the printer 27 finishes printing the receipt, the processor 21 finishes the information processing shown in FIG. 4.

As described above, in accordance with the coupon distribution system 100, a coupon provided from a provider such as a manufacturer and a former seller is issued by the POS terminal 20 and given to a shopper. That is, information regarding the coupon is provided from the provider to the shopper who is a recipient under the mediation of a retailer that operates the POS terminal 20. Then, as the coupon to be issued by the POS terminal 20, a coupon in which the incentive that matches the incentive condition preset for the POS terminal 20 is set as the incentive for the retailer is selected.

Incidentally, in general, a coupon for which a large incentive is set has a stricter issuance condition and a smaller issuance amount than a coupon for which a smaller incentive is set. For this reason, by setting a threshold value “oo yen or more” as the incentive condition and increasing the threshold value, it is possible to reduce the amount of coupons to be issued by the POS terminal 20. In the case where the amount of coupons to be issued is reduced, it is possible to reduce the retailer's cost for issuing coupons. Meanwhile, there is a possibility that the acquisition amount of incentives as a whole is reduced and the effect of attracting customers by the coupon is limited due to the reduction in the amount of issued coupons. In this regard, by setting a threshold value “oo yen or more” as the incentive condition and adjusting the threshold value, it is possible to balance the retailer's burden and gain for issuing coupons in accordance with the circumstances of the retailer.

Further, for example, in the case of a store where there are many shoppers who prefer to frequently get a small privilege for the purchase of daily necessities, it is also possible to issue only coupons suitable for such shoppers by setting a threshold value “oo yen or less” as the incentive condition and adjusting the threshold value. As a result, by not issuing coupons that are unlikely to be used due to the strict application condition, it is possible to reduce the retailer's cost for issuing the coupons. In this way, in accordance with this embodiment, it is possible to issue a coupon that appropriate for a retailer who is an intermediary.

Further, in accordance with this embodiment, the incentive condition can be individually set for each of the plurality of POS terminals 20. For this reason, for example, even in the plurality of POS terminals 20 installed in the same store, by making the incentive condition of the POS terminal 20 installed in the sales floor for high-priced products and the incentive condition of the POS terminal 20 installed in the sales floor for low-priced products differ, appropriate coupons corresponding to the characteristics of the respective sales floors can be issued.

This embodiment can be variously modified as follows. The condition data CD1 may be common to all the POS terminals 20 provided in the same store or all the POS terminals 20 operated by the same retailer. In this case, the condition data CD1 may be stored only in a part of the plurality of corresponding POS terminals 20, or may be stored in another apparatus such as a POS server, which belongs to the same POS system.

The condition data CD1 may be stored in the coupon server 10 in association with each of the POS terminals 20, a store, or a retailer. In this case, the POS terminal 20 does not notify the coupon server 10 of the condition data CD1 during the inquiry in ACT4 shown in FIG. 4. Then, in the coupon server 10, the processor 11 identifies the POS terminal 20 that is the source of the inquiry, the store in which the POS terminal 20 that is the source of the inquiry is provided, or the retailer that operates the POS terminal 20 that is the source of the inquiry. The processor 11 refers to the condition data CD1 stored in association with the POS terminal 20, the store, and the retailer, and determines the coupon to be issued.

The condition data CD1 may include data indicating a condition relating to the type of the coupon that is allowed to be issued, in addition to the incentive condition. The condition relating to the type may be arbitrarily set by the administrator of the POS terminal 20, or the like. The condition relating to the type is set to, for example, “Limited to coupons relating to foods” or “Exclude coupons that makes reduction or discounts from total amount”. In the case where the condition data CD1 indicates a condition other than the incentive condition, the processor 11 performs also narrowing down corresponding to the condition and determines a coupon to be issued.

In the above-mentioned embodiment, in order to provided information regarding a coupon to a shopper, the coupon obtained by printing an image representing the surface of the coupon on a receipt paper is issued. However, the output form of information regarding a coupon can be arbitrarily changed, e.g., information regarding a coupon is transmitted to an information terminal that a shopper has by using, for example, wireless communication.

Further, the information provided in the above-mentioned embodiment is not limited to information regarding a coupon and may be information for giving a privilege to a shopper, such as advertisement information, sale information, and voucher information. Further, the information provided in the above-mentioned embodiment may be arbitrary information for performing notification on a shopper, such as regional information and event information.

The processor 11 may omit any one of the processing of ACT11 and the processing of ACT12 shown in FIG. 5. Further, the processor 11 may perform narrowing down corresponding to another condition and determine a coupon to be issued.

Information output such as issuing a coupon may be performed by an arbitrary apparatus having a function as an information providing apparatus. The arbitrary apparatus is, for example, an apparatus such as a multi-copy machine, an information terminal, a registration apparatus or payment apparatus of a semi-self checkout system, and a signage apparatus. Further, information output such as issuing a coupon may be performed by an independent dedicated information providing apparatus.

A part or all of the functions realized by the processor 11 or 21 by information processing can also be realized by hardware that executes information processing not based on a program, such as a logic circuit. Further, each of the above-mentioned functions can also be realized by combining the above-mentioned hardware such as a logic circuit with software control.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information management apparatus, which is to be communicably connected to a providing apparatus operated by an intermediary and managing a plurality of pieces of to-be-provided information, the intermediary providing, to a customer, to-be-provided information from an information provider, the plurality of pieces of to-be-provided information being output by the providing apparatus, the information management apparatus comprising:
a communication interface that communicates with the providing apparatus;
a storage device that stores incentive data in association with the to-be-provided information, the incentive data indicating an incentive to be given from the information provider to the intermediary; and
a processor configured to:
acquire, as the incentive, an incentive condition preset for the providing apparatus,
select, from the plurality of pieces of to-be-provided information stored in the storage device, to-be-provided information with which the incentive data that matches the acquired incentive condition is associated, and
output the selected to-be-provided information to the providing apparatus via the communication interface.

2. The information management apparatus according to claim 1, wherein the processor:
acquires inquiry data from the providing apparatus via the communication interface, the inquiry data including the incentive condition, and
selects, from the plurality of pieces of to-be-provided information stored in the storage device, the to-be-provided information with which the incentive data that matches the incentive condition included in the acquired inquiry data is associated.

3. The information management apparatus according to claim 2, wherein
the storage device further stores a plurality of pieces of store condition data in association with the plurality of pieces of to-be-provided information, each of the plurality of pieces of store condition data indicating a store of the intermediary in which the providing apparatus is provided, and
the processor:
acquires the inquiry data including data regarding the store from the providing apparatus,
extracts, from the plurality of pieces of to-be-provided information stored in the storage device, the to-be-provided information associated with the store condition data that matches the data regarding the store included in the acquired inquiry data, and
selects, from the extracted to-be-provided information, the to-be-provided information with which the incentive data that matches the incentive condition included in the acquired inquiry data is associated.

4. The information management apparatus according to claim 3, wherein
the storage device further stores a plurality of pieces of transaction condition data in association with the plurality of pieces of to-be-provided information, each of the plurality of pieces of transaction condition data indicating content of a commercial transaction between the intermediary and the customer, and
the processor:
acquires, from the providing apparatus, the inquiry data including data regarding the content of a commercial transaction,
extracts, from the to-be-provided information extracted with reference to the store condition data, the to-be-provided information associated with the transaction condition data that matches the data regarding the content of a commercial transaction included in the acquired inquiry data, and
selects, from the to-be-provided information extracted with reference to the transaction condition data, the to-be-provided information with which the incentive data that matches the incentive condition included in the acquired inquiry data is associated.

5. The information management apparatus according to claim 1, wherein
the storage device further stores a plurality of pieces of image data in association with the plurality of pieces of to-be-provided information, the plurality of pieces of image data representing the plurality of pieces of to-be-provided information, and
the processor:
acquires, from the plurality of image data stored in the storage device, image data associated with the selected to-be-provided information, and
outputs, to the providing apparatus, the acquired image data together with the selected to-be-provided information.

6. The information management apparatus according to claim 1, wherein
the storage device further stores the incentive condition preset for the providing apparatus, and
the processor:
acquires the incentive condition from the storage device, and
selects, from the plurality of pieces of to-be-provided information stored in the storage device, the to-be-provided information associated with the incentive data that matches the acquired incentive condition.

7. An information providing system, comprising:
a providing apparatus to be operated by an intermediary that provides, to a customer, to-be-provided information from an information provider; and
an information management apparatus that manages a plurality of pieces of to-be-provided information output by the providing apparatus, wherein
the providing apparatus includes:
a first communication interface that communicates with the information management apparatus,
a first storage device that stores, as an incentive to be given from the information provider to the intermediary, a preset incentive condition, and
a first processor configured to:
transmit the incentive condition stored in the first storage device to the information management apparatus via the first communication interface, and
acquire, as a response to the transmission of the incentive condition, the to-be-provided information from the information management apparatus via the first communication interface; and
the information management apparatus includes:
a second communication interface that communicates with the providing apparatus,
a second storage device that stores incentive data in association with the to-be-provided information, the incentive data indicating the incentive to be given from the information provider to the intermediary, and
a processor configured to:
acquire, via the second communication interface, inquiry data including the incentive condition transmitted from the providing apparatus,
select, from the plurality of pieces of to-be-provided information stored in the second storage device, to-be-provided information with which the incentive data that matches the incentive condition included in the acquired inquiry data is associated, and
output the selected to-be-provided information to the providing apparatus via the second communication interface.

8. The information providing system according to claim 7, wherein
the providing apparatus further includes an output device that outputs the acquired to-be-provided information, and
the first processor:
performs information processing for payment relating to a commercial transaction between the customer and the intermediary,
transmits the incentive condition to the information management apparatus accompanying the information processing, and
causes the output device to output the to-be-provided information acquired via the first communication interface after the information processing.

9. The information providing system according to claim 8, wherein
the output device includes a printer, and
the first processor causes the printer to print the to-be-provided information acquired via the first communication interface.

10. An information processing method for an information management apparatus, which is communicably connected to a providing apparatus operated by an intermediary and managing a plurality of pieces of to-be-provided information, the intermediary providing, to a customer, to-be-provided information from an information provider, the plurality of pieces of to-be-provided information being output by the providing apparatus, the information processing method comprising:
storing, in a storage device, incentive data in association with the to-be-provided information, the incentive data indicating an incentive to be given from the information provider to the intermediary;
acquiring, as the incentive, an incentive condition preset for the providing apparatus;
selecting, from the plurality of pieces of to-be-provided information stored in the storage device, to-be-provided information with which the incentive data that matches the acquired incentive condition is associated; and
outputting the selected to-be-provided information to the providing apparatus via a communication interface.
